(19) United States
(12) Patent Application Publication
(10) Pub. No.: US 2017/0061382 A1
(43) Pub. Date: Mar. 2, 2017

(54) SYSTEM FOR RECRUITMENT

(71) Applicant: Brilent, Inc., San Mateo, CA (US)

(72) Inventors: Weihong Zhang, Sharon, MA (US); Guangrui Garry Ma, San Mateo, CA (US); Yihua Liao, Fremont, CA (US); Charles Marshall, Atherton, CA (US); Peter Zhu, Acton, MA (US)

(73) Assignee: Brilent, Inc.

(21) Appl. No.: 15/224,354

(22) Filed: Jul. 29, 2016

Related U.S. Application Data
(60) Provisional application No. 62/211,569, filed on Aug. 28, 2015.

(51) Int. Cl. G06Q 10/10; H04L 29/08

(52) U.S. Cl. CPC G06Q 10/1053; H04L 67/02; G06F 3/0481

(57) ABSTRACT

A system for management of recruitment data may include (a) an interface for receiving and providing over a wide area computer network data regarding job openings and data regarding candidates to be matched to such job openings; (b) a database for storing the data regarding job openings and the data regarding the candidates, the database being organized according to one or more entity-relationship models; and (c) a computing hardware platform for executing a processing engine that is machine-learned from the data regarding job openings and the data regarding candidates, wherein the processing engine (a) creates the entity-relationship models over time; (b) manages the interface to receive the data regarding job openings and the data regarding candidates and causing the received data to be stored in the database; (c) matches candidates whose data are currently in the data base to job openings currently in the database; (d) receives historical data regarding actual filling of job openings in the database by candidates in the data base; and (e) refines the entity-relationship models and the matching of current candidates to current job openings based on the historical data.

### CROSS REFERENCE TO RELATED APPLICATION

The present application claims priority from U.S. Provisional Patent Application Ser. No. 62/211,569, filed on Aug. 28, 2015. The application is hereby incorporated by reference herein in its entirety

### BACKGROUND OF THE INVENTION

1. Field of the Invention

The present invention relates to a system for managing employment information and for matching potential employees to job openings at employers.

2. Discussion of the Related Art

In conventional recruitment practice, a recruiter spends significant portion of his or her time on the job sourcing and reviewing resumes of potential employees and matching the potential employees to the available jobs. From a potential employee's perspective, identifying potential employers with suitable positions and getting his or her resume into the appropriate channels to reach such potential employers are time-consuming and complex tasks. As most employers and employees know, the most qualified potential employees are often those who are already in comfortable positions and are unlikely to be actively seeking the next job.

Economists refer to the recruitment and job-seeking processes as a “two-sided matching” problem, with significant transactional costs (e.g., time, material and information costs) incurred in bringing the well-matched employer and employee together. Thus, any tool that automates, simplifies or facilitates the process of identifying and matching the desirable candidates to suitable job openings are economically significant.

### SUMMARY

According to one embodiment of the present invention, a system for management of recruitment data includes (a) an interface for receiving and providing over a wide area computer network data regarding job openings and data regarding candidates to be matched to such job openings; (b) a database for storing the data regarding job openings and the data regarding the candidates, the database being organized according to one or more entity-relationship models; and (c) a computing hardware platform for executing a processing engine that is machine-learned from the data regarding job openings and the data regarding candidates, wherein the processing engine (a) creates the entity-relationship models over time; (b) manages the interface to receive the data regarding job openings and the data regarding candidates and causing the received data to be stored in the database; (c) matches candidates whose data are currently in the data base to job openings currently in the database; (d) receives historical data regarding actual filling of job openings in the database by candidates in the data base; and (e) refines the entity-relationship models and the matching of current candidates to current job openings based on the historical data.

In one embodiment of the present invention, the interface may include one or more servers for maintaining one or more web portals for access by users over the wide area computer network. One such web portals is one that is customized for use by recruiting professionals. In that web portal, a user can upload of job openings and candidate profiles, and receives matching of candidates in the current data base with job openings in the current data base. Another one of such portals is a web portal customized for use by candidates to job openings. In addition to providing a candidate's own profile information, the web portal for use by candidates may administer on-line technical competency tests and non-technical surveys or questionnaires to the candidates. Parsers are provided in the interface with the web portals to identify relevant information from the free form resumes and job descriptions.

According to one embodiment of the present invention, a system of the present invention may include a third party integration module for allowing data to be obtained or to be provided to third party programs. Such third party programs may include applicant tracking systems, candidate sourcing systems, and sources of professional and personal data. Additional data regarding the candidates may be obtained from third party programs.

According to one embodiment of the present invention, a system of the present invention may include a web crawler that provides the system data regarding candidates through exploration of information available on the wide area network.

Systems of the present invention provide more effective use of both available and acquired data to evaluate how well a candidate matches a particular job or role. According to one embodiment, data regarding a candidate collected through, for example, the candidate's curriculum vitae, data collected on-line from social and other online profiles and activities, for example, are supplemented with data collected through questionnaires or competence testing of the candidate. Such a process provides a direct evaluation of a candidate's skill qualifications and cultural fit. Using machine learning techniques to exploit deep and unapparent correlations among the data in a knowledge base, the signal and accuracy of how well a candidate will fit a particular job role may be developed. At each step, data is collected and fed back into the core engine to improve the accuracy of the candidate scoring.

The present invention is better understood upon consideration of the detailed description below in conjunction with the accompanying drawings.

### BRIEF DESCRIPTION OF THE DRAWINGS

FIG. 1 shows information flow diagram 100 which illustrates the collection and analysis of data suitable for implementing such a recruitment tool, in accordance with one embodiment of the present invention.

FIG. 2 is a functional block diagram showing the major functional modules in system 200, in accordance with one embodiment of the present invention.

### DETAILED DESCRIPTION OF THE PREFERRED EMBODIMENTS

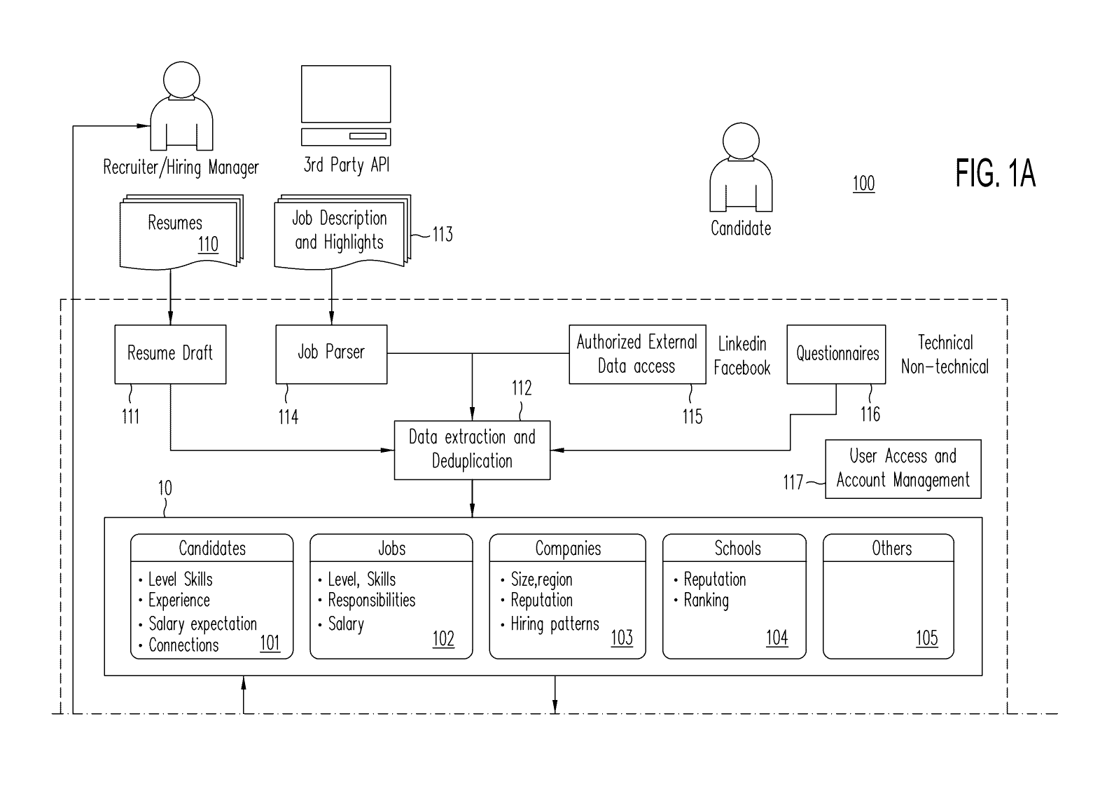

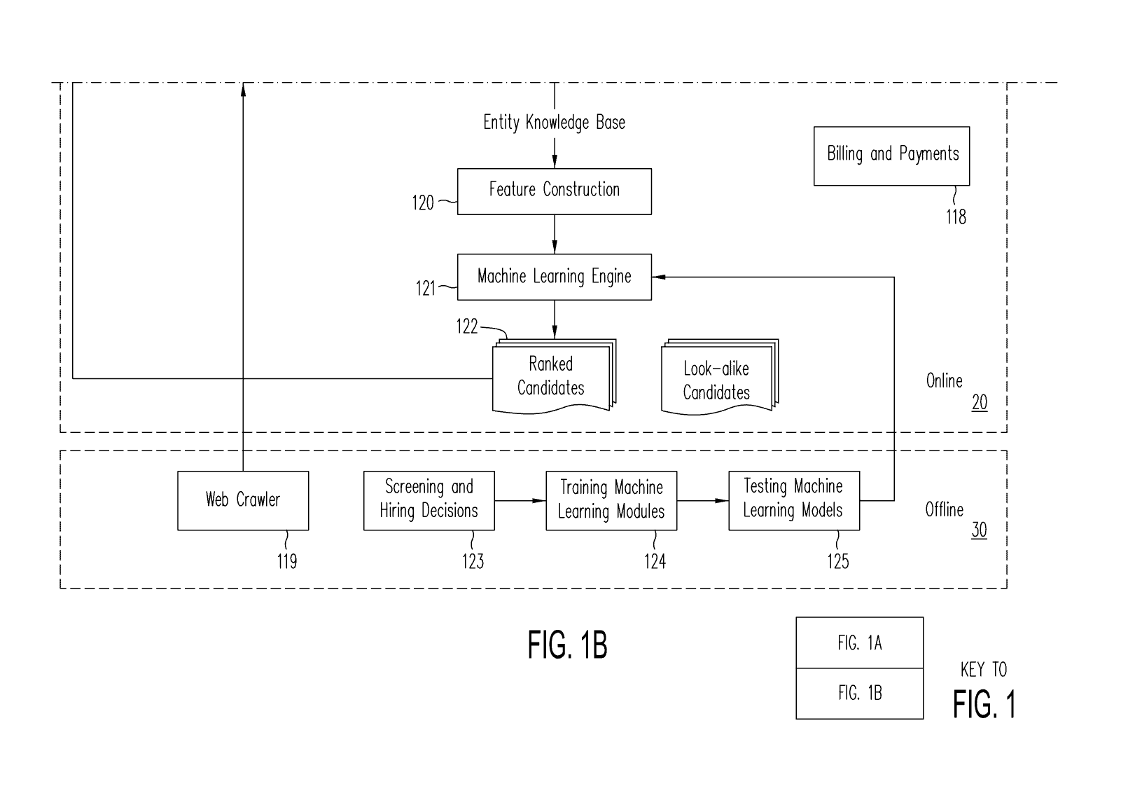

According to one embodiment of the present invention, a recruitment tool (“talent finder”) allows a user—who may be a recruiter or a hiring manager—to evaluate a large number of candidates to specific job requirements. FIG. 1 shows information flow diagram 100 which illustrates the collection and analysis of data suitable for implementing such a recruitment tool, in accordance with one embodiment of the present invention. The recruitment tool includes entity knowledge base 10 (also known as Entity Graph), which is a repository of information or database containing data collected from a variety of sources. As shown in FIG. 1, entity knowledge base 10 may include data of a variety of related data categories, e.g., candidates 101, job openings 102, company profiles 103, school profiles 104 and other data categories 105. The data within entity knowledge base 10 may be organized in one or more entity-relationship models (“entity-based knowledge graphs”), both within the data categories and across the data categories.

As shown in FIG. 1, data in entity knowledge base 10 regarding candidates for job openings may be sourced from resumes (represented in FIG. 1 by resumes 110) submitted by or collected from the candidates. For example, a user may upload one or more curricula vitae (“CVs”) or resumes. Such a user may be a recruiter or a job seeker. Typically, these documents are free-form. Thus, an automated tool (“resume parser 111”) then parses the CVs or resumes for relevant information. Another automated tool (“data extraction tool 112”) extracts the identified relevant information and integrates the data into entity knowledge base 10 according to how the extracted data fit into the entity-based knowledge graphs. Optionally, data extraction tool 112 may also check if relevant information is collected of a given candidate and avoids entering any duplicate information into entity knowledge base 10.

Similarly, a user may also upload one or more job descriptions (e.g., job descriptions 113). Each job descriptions is then parsed by a job description parser (“job parser 114”). The parsed job description is also presented to data extraction tool 112, which extracts and integrates the relevant job description information into knowledge entity 10.

Information regarding the candidates may also be collected from appropriate social and professional media websites or tools 115 (e.g., Linked-in or Facebook). The candidates themselves may also be willing to provide information outside of their CVs or resumes (e.g., through surveys or questionnaires). In some instances, it may be appropriate to collect candidate information from broader sources (e.g., using a “data scraper” 119).

Based on the information collected and organized under the entity-based knowledge graphs, and a set of predetermined evaluation criteria (“feature construction 120”), a machine learning-based program (“core engine 121”) evaluates each candidate against each job opening to provide a set of scores 122 representing how well the candidate matches the specific job requirements of the job opening. If the user desires additional information of the candidates, the user may request that the candidates be surveyed using questionnaires, or be asked to perform specific test tasks intended for evaluating technical competence, non-technical aptitude, interest level and other criteria. After the questionnaires or test tasks are completed, the resulting additional information is incorporated into entity knowledge base 10 to allow further refinement of the candidate's scores. Where appropriate, the data collected of each candidate may be made available to all users.

It is expected that the scores generated by a recruitment tool of the present invention be instrumental to the hiring decision. Thus, hiring decisions, whether positive or otherwise, may be used to improve system performance. For example, core engine 121 may be trained using historical “screening and hiring decisions 123”. The training process allows core engine 121 to recognize patterns in the candidate selection process, even specific to a particular user, to provide better accuracy and a more positive user experience. The training process may be achieved using conventional machine-learning and testing techniques 124 and 125. Improvement in performance based on machine-training techniques may be shared across users.

Access control, account management, and other administrative functions 117 may be implemented to ensure privacy and integrity. Billing and payment functions 118 may also be implemented. The system may also interface with external software through, for example, application program interfaces.

In FIG. 1, activities shown within box 20 may be carried out on-line (i.e., interactively with a user or candidate through a graphical user interface). These on-line activities may include resume parsing in resume parser 111 and job opening parsing in job parser 112, candidate scoring and ranking 122, and on-line questionnaire interaction 116 with a candidate. Activities shown in box 30 may be considered “offline” activities, i.e., activities that are performed without interaction with a user or a candidate. Such activities include web crawling in web crawler 119, machine model retraining 124 and testing 125 may be run in the backend, either automatically or in ad hoc fashion.

According to one embodiment of the present invention, data collected from candidate CVs or resumes may include contact information (e.g., email addresses, telephone numbers, postal addresses), education background (e.g., universities or schools attended, academic credentials, including degrees obtained, grade point averages and scholarship awards), work and other experiences (e.g., industry companies or academic institutions worked for, full-time or part-time positions held, previous job titles, tenure, and responsibilities), relevant skills, list of publications, patents held, leadership and social involvements, and professional memberships. Such data may be augmented using candidate-provided links to external sources of professional information, such as LinkedIn and Github accounts. For example, as an indicator of the candidate's technical skill set, one may collect the number of contributions in the candidate's GitHub account, with different weights assigned to repositories of different popularity.

Data collected form job opening descriptions may include the company posting the job opening, job title, job location, responsibilities, required or desired skills, and highlighted keywords. Highlighted keywords are keywords supplied by the user to indicate to the system certain pieces of information that should be accorded greater weight. For example, if a company heavily uses certain programming languages or software packages, highlighted keywords may be, for example, C++, python, C# etc.

In addition to data collected through CVs and resumes, additional data may be collected through interaction with a candidate over a user interface. Such data may include specific skills, educational background or industry experience the candidate would like to highlight, and the candidate's connections and endorsements. Correlation of the candidate's connections and endorsements with the reported work experience may be useful to validate the candidate's rating.

In one embodiment, a non-technical survey is conducted with a the candidate to elicit personality traits (e.g., active or passive personality), whether or not the candidate is open to a contractor position, as opposed to an employee position, the candidate's willingness to relocate, the profile of the company sought, the candidate's salary expectation, and the candidate's legal ability to work (e.g., visa status).

In one embodiment, the system collects additional information from the world-wide web, using web-crawling or data-scraping techniques. Such additional data includes information regarding the universities candidates attended (e.g., prestige, ranking of specific academic programs, specific degrees awarded etc.). To help evaluate the substantiality of a candidate's experience, for example, such data may also include company profiles, ranking, corporate reputation or culture, and size. Company profile data may be collected from, for example, Global public 2000 companies by market size, US largest private companies, Largest startups by valuation, etc. Other information that may be of value include salary surveys, as correlated with H1B sponsorship (available from, e.g., http://www.flcdatacenter.com/Download.aspx), and with region and occupation (available from, e.g., http://www.bls.gov/bls/blswage.htm. Other helpful information that may be collected for evaluation of suitability for an job opening may be, for example, a company's rating (available, e.g., Glassdoor.com) and other indicia of a company's reputation. To evaluate the relevance of a candidate's skills and experience in certainly industries or markets (e.g., foreign markets, such as China), data may be sourced through data partnership or other sources (e.g., crowd sourcing).

The entity-based knowledge graphs encompass all entities in entity knowledge base 10. Examples of entities include candidates, universities, academic institutions and schools, academic programs (e.g., Physics Graduate Program at Stanford University), industries (e.g., software engineering, data science), companies and jobs. The entities in the entity-based knowledge graphs are linked by edges that capture the relationships or interactions between the entities. These relationships represent facts (e.g. the candidate's alma mater, the degree or degrees received, the company the candidate is currently with, and the current title), the probabilities that the candidate possesses specific skills (i.e. the likelihood that the candidate is proficient in a specific programming language), the probabilities of the candidate being desirous of specific jobs, and the probabilities that the company having the job opening is desirous of a person having specific personal and professional traits. For example, such data captures relationships that would the system to conclude that company A hires candidates from top-tier MBA graduate programs 85% of the time for job C. The entity-based knowledge graphs are periodically updated, so as to reflect the latest status of the entities and the interactions among them.

In order to properly and accurately capture all relationships and interactions among entities in the entity-based knowledge graphs, a domain-specific taxonomy is developed. For example, the system is cognizant that “Experience with Oracle SQL, Microsoft SQL Server and MySQL” may be treated in most respects the same as “SQL experience.” Similarly, the system is cognizant that “Object-oriented programming languages” includes “Python”, “C++”, “Java”, etc.

The entity-based knowledge graphs allow features to be constructed that relate a candidate to a job. These features allow predictive models to be built, using regression, random forest and other suitable data-driven learning techniques to estimate the fit between the candidate and the job. Some example features include (a) academic credentials (e.g., numerical values may be assigned to B.S., M.S. and Ph.D. degrees); (b) number of years of professional experience; (c) similarities between current job responsibilities and the responsibilities specified in the job description (e.g., based on keyword and semantic matching); (d) quality of the alma mater (e.g., different numerical values may be assigned to different universities, which may be grouped into tiers); (e) difference between the candidate's current salary and the salary range offered in the job description; (f) number of years the candidate stayed at each previous job; and (f) number of years of experience in each skill highlighted by the user.

The system may also use these features to calculate a measure of similarity (“distance”) between candidates. Accordingly, the system provides a “lookalike candidate” feature to include or exclude candidates to be recommended for a job opening. When a user indicates that a candidate is a “strong fit” or “weak fit” for a job, the system may use that candidate as a reference to compute a distance between that candidate and each candidate in the candidate pool. The candidate with a small distance to the reference candidate may have his or her ranking upgraded or downgraded for the specific job opening, according to whether the reference candidate was rated as a “strong fit” or “weak fit,” respectively. A user's indication of preference or disfavor helps the system to quickly train the system to learn the user's specific preference or disfavor, thereby improving the effectiveness of the recommendation. The distance measure may be based on a single feature, e.g., university education, the system may recommend another candidate who attends the same university and graduated from the same program. For a distance measure based on multiple features, the system may use a “weighted cosine similarity metric.” For example, assuming the features “salary” and “number of years of experience” of two candidates A and B are represented by the tuples (s_{A}, e_{A}) and (s_{B}, e_{B}), respectively, and these features are weighted wₛ and wₑ, then the distance measure, using the weighted cosine similarity metric, would be given by

$$\frac{{w}_{s} {s}_{A} {s}_{B} + {w}_{e} {e}_{A} {e}_{B}}{\sqrt{{w}_{s} ( {s}_{A}^{2} + {s}_{B}^{2} ) + {w}_{e} ( {e}_{A}^{2} + {e}_{B}^{2} )}} .$$

The values s_{A}, e_{A}, s_{B}, e_{B}, ws and wₑ are suitably normalized values, using normalization techniques familiar to those of ordinary skill in any of the fields of machine learning, and probabilities and statistics.

The system may offer online skill or competence testing to more accurately evaluate a candidate's technical proficiency. Results of the testing are fed into the machine-learning algorithms, together with other information that is gathered programmatically from the candidate's resume, LinkedIn profile, and other online activities. For example, one embodiment provides tests that cover essential technical skills that are required in data science, software engineering and other related fields. The tests may focus, for example, on real-world problem solving and understanding of fundamental concepts (e.g., statistical significance and computational cost), which are known to be critical to career success in such fields. Such tests are invaluable to obtain skill and competence data that is not available in relatively quantified form from the candidate's resume or his or her LinkedIn profile. Examples of areas in which such tests are appropriate include: proficiencies with SQL, Python, statistics, Hadoop, C++, Java, and Ruby. In one embodiment, the tests are designed to be: (a) light-weighted, i.e., each test may consist, for example, of 15 or less multiple-choice questions, with an appropriate time limit (e.g., 15 minutes); (b) easily accessed (e.g., a candidate may elect to take such a test from a desktop computer or a mobile phone at any time, and wherever he or she finds convenient); (c) flexible (e.g., a recruiter or hiring manager may specify for the candidates which test or tests to take, deemed most relevant to the job requirements; and (d) available (i.e., the test results are stored in the system for a relevant time period, and are made available to all recruiters selected by the candidate.

The system may also compile insightful, detailed summary of the candidate's performance on the tests including, for example, how the candidate ranks relative to his or her peers, as well as the areas or topics in which the candidate performed well. In one embodiment, the summary report may read: “This candidate ranked the 86^{th} percentile in statistics, and demonstrated good knowledge of probability, sampling, and experiment design . . . .”

Suitable security features are implemented in the system to prevent cheating or other fraudulent actions (e.g., a candidate having another person take a test). Suitable security measures require a candidate to submit adequate identification to prevent fraud (e.g., a biometric signature).

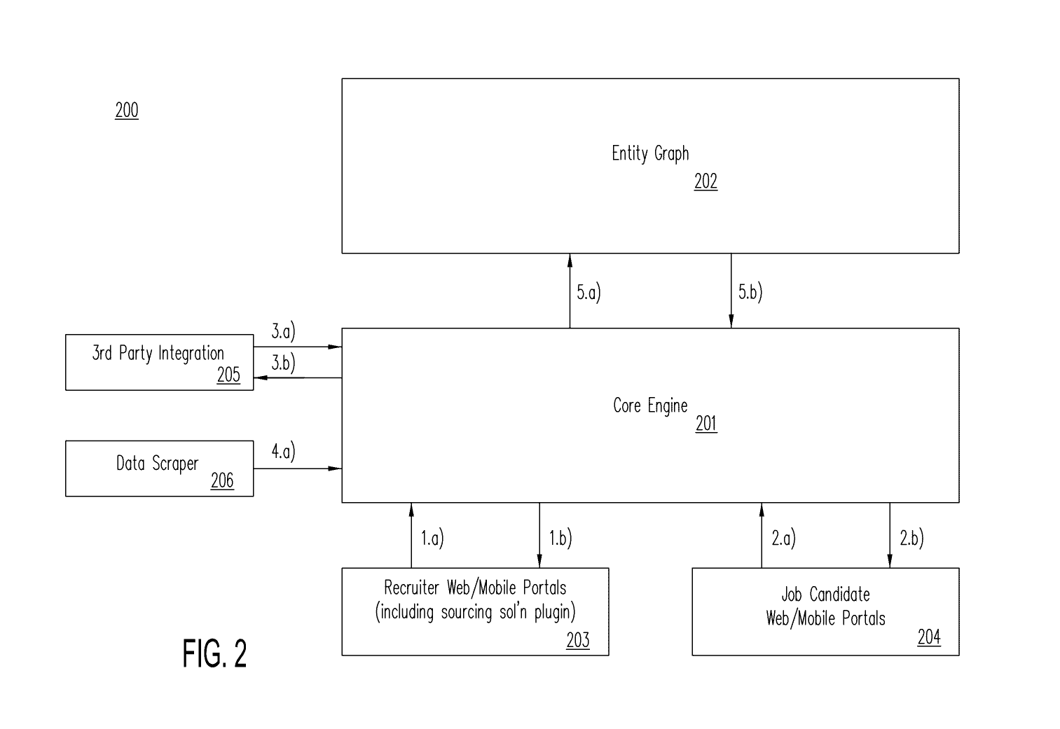

FIG. 2 is a functional block diagram showing the major functional modules in system 200, in accordance with one embodiment of the present invention. As shown in FIG. 2, system 200 includes core engine 201, which may be software carrying out the core functions of system 200, including matching candidates to available jobs. Core engine 201 also constructs and maintains the entity-based knowledge graphs in the entity graph module 202. In one embodiment, as candidate data (e.g., a resume) or job description data is received or uploaded, core engine 201 tags the data with one or more relevant job classifications (based on the domain-specific taxonomy) to allow subsequent efficient processing. In this manner, candidates and job data classified to a specific job classification and related classifications may be very efficiently identified and processed. Providing such pre-processing allows system 200 to be scalable as the managed data grows.

Entity graph module 202 includes data organized by entities and relationships relating the entities. As discussed above, entities may be, for example, candidates, work places, job titles, educational institutions, degrees, school courses, projects, locations, computer languages, and so forth. The relationships may represent facts (e.g. the candidate's alma mater, the degree or degrees received, the company the candidate is currently with, and the current title), the probabilities that the candidate possesses specific skills (i.e. the likelihood that the candidate is proficient in a specific programming language), the probabilities of the candidate being desirous of specific jobs, and the probabilities that the company having the job opening is desirous of a person having specific personal and professional traits. Core engine 201 may retrieve from or save into entity graph module 202 data corresponding to any subset of entities and relationships.

Core engine 201 also manages recruiter web or mobile portals 203 (“recruiter portals 203”) and candidate web or module portals 204 (“candidate portals 204”). Through recruiter portals 203, a user may upload job descriptions and candidate CVs and resumes, review job and candidate data from the user and other sources, provide user-specific candidate preference and other data, access third party tools, and review recommendations of candidate-job opening matches from core engine 201. Core engine 201 also provides through recruiter portals 203 additional data helpful recruiters (e.g., suggested job description template and key phrases to be added to the user-provided job descriptions).

Through candidate portals 204, a candidate may upload his or her resume, and authenticated his or her professional and personal data that core engine 201 obtains from third party applications (e.g., LinkedIn, Facebook, and other social and professional sources). Core engine 201 also administers technical competence tests through candidate portals 204. Through candidate portals 204, a candidate may examine his or her matches to specific job openings recommended by core engine 201, and other employment related data (e.g., how the candidate matches up to his or her peers in similar jobs, similar industries, similar locations and other parameters.

In some embodiment, a plug-in may be provided to a web browser that is used to access recruiter portals 203 and candidate portals 204. The plug-in provides access to the functions that are specific to core engine 201. For example, the plug-in allows a user to access inline information about a candidate from any website on which the candidate's name appears.

Core engine 201 also interfaces with third party applications through third party integration module 205. In one embodiment, third party integration module 205 provides core engine 201 access to such systems as an applicant tracking systems (“ATS”), job boards, tools that focus on candidate sourcing (e.g. Entelo, Piazza, etc), a human resource management system (HRM), and other systems providing additional data (e.g., candidate profiles, feedback on candidates, and recruiter preferences). In addition, third party integration module 205 may share data maintained by core engine 205 with third party software through third party integration module 205. Integration with an ATS allows tracking of candidates through the hiring process. Integration with job boards allow access to additional candidate profile data and tracking of the jobs on each job board that a candidate may have applied.

In one embodiment, core engine 201 receives data from one or more web crawlers and data scrapers, represented in FIG. 2 by data scraper 206. Similar to integration with third party applications, integration with a web crawler or data scraper allows users and data partners to access additional data for enhancing the entity-based knowledge graphs. For example, through third party integration module 205, core engine 201 accesses candidate profile data from social and professional data repositories (e.g. Facebook, LinkedIn, Github, and Quora) and other online databases (e.g. salary data from H1B gov website and Glassdoor). Such third party data may be gathered and aggregated to augment building and refinement of the entity-based knowledge graphs.

The above detailed description is provided to illustrate specific embodiments of the present invention and is not intended to be limiting. Numerous variations and modifications within the scope of the present invention are possible. The present invention is set forth in the accompanying claims.

We claim:

1. A system for management of recruitment data, comprising:
an interface for receiving and providing over a wide area computer network data regarding job openings and data regarding candidates to be matched to such job openings;
a database for storing the data regarding job openings and the data regarding the candidates, the database being organized according to one or more entity-relationship models; and
a computing hardware platform for executing a processing engine that is machine-learned from the data regarding job openings and the data regarding candidates, wherein the processing engine (a) creates the entity-relationship models over time; (b) manages the interface to receive the data regarding job openings and the data regarding candidates and causing the received data to be stored in the database; (c) matches candidates whose data are currently in the data base to job openings currently in the database; (d) receives historical data regarding actual filling of job openings in the database by candidates in the data base; and (e) refines the entity-relationship models and the matching of current candidates to current job openings based on the historical data.

2. The system of claim 1, wherein the interface comprises one or more servers for maintaining one or more web portals for access by users over the wide area computer network.

3. The system of claim 2, wherein the web portals comprise a web portal customized for use by recruiting professionals.

4. The system of claim 3, wherein the web portal customized for use by recruiting professionals receives uploads of job openings and candidate profiles, and provides to the recruiting professionals the matching of candidates in the current data base with job openings in the current data base.

5. The system of claim 2, wherein the web portals comprise a web portal customized for use by candidates to job openings.

6. The system of claim 5, wherein the web portal customized for use by candidates administers on-line technical competency tests to the candidates.

7. The system of claim 2, wherein the web portals receiving uploading of candidate resumes, wherein the web portals each comprise a parser for identifying the data regarding candidates from the candidate resumes.

8. The system of claim 2, wherein the web portals receiving uploading of job opening descriptions, wherein the web portals each comprise a parser for identifying the data regarding job openings from the job opening descriptions.

9. The system of claim 1, further comprising a third party integration module for allowing data to be obtained or to be provided to third party programs.

10. The system of claim 9, wherein the third party programs comprise at least one of: one or more applicant tracking systems, one or more candidate sourcing systems, and one or more sources of professional and personal data.

11. The system of claim 9, wherein a portion of the data regarding the candidates is obtained from third party programs.

12. The system of claim 1, further comprising a data scraper that provides the system data regarding candidates through exploration of information available on the wide area network.

13. The system of claim 1, wherein the processing engine further recommends candidates to fill a job opening based on learned user preferences.

14. The system of claim 13, wherein the user preferences relative to job are learned from a user's ratings of one or more candidates matched to the job opening.

15. The system of claim 14, wherein the processing engine recommends candidates to the job opening based on a distance measure based on one or more characteristics of each candidate to be recommended and the corresponding characteristics of the one or more rated candidates.
